(19) United States
(12) Patent Application Publication
(10) Pub. No.: US 2005/0151961 A1
(43) Pub. Date: Jul. 14, 2005

(54) Surface layer atmospheric turbulence differential image motion measurement

(76) Inventors: John T. McGraw, Placitas, NM (US); Peter C. Zimmer, Albuquerque, NM (US); Mark R. Ackermann, Albuquerque, NM (US)

Correspondence Address: Schwegman, Lundberg, Woessner & Kluth, P.A., P.O. Box 2938, Minneapolis, MN, 55402, US

(21) Appl. No.: 11/016,966

(22) Filed: Dec. 20, 2004

Related U.S. Application Data
(60) Provisional application No. 60/533,670, filed on Dec. 31, 2003.

(51) Int. Cl. G01J 1/00

(52) U.S. Cl. 356/121

(57) ABSTRACT

Apparatus and methods for surface layer atmospheric turbulence differential image motion measurement provide the ability to measure and characterize the atmospheric turbulence in a surface boundary layer with applications to a wide variety of technical areas including, but not limited to, astronomy and atmospheric conditions for take-off and landing at airports. Methods and apparatus include multiple optical sources and a receiver having sub-apertures for detecting light traveling along independent paths from the optical sources to the sub-apertures. The sub-apertures of the receiver are arranged, including relative spacing, to match the geometric arrangement of the multiple optical sources, where there is one sub-aperture for each optical source. Appropriate images received by the sub-apertures are analyzed using differential image motion measurement techniques.

### RELATED APPLICATIONS

This application claims priority under 35 U.S.C. 119(e) from U.S. Provisional Application Ser. No. 60/533,670 filed 31 Dec. 2003, which application is incorporated herein by reference.

### GOVERNMENT INTEREST STATEMENT

This invention was made with Government support under Contract DE-AC04-94AL85000 awarded by the United States Department of Energy. The Government has certain rights in the invention.

### FIELD OF THE INVENTION

This invention relates generally to turbulence in the atmosphere, more particularly to surface layer atmospheric turbulence.

### BACKGROUND OF THE INVENTION

Many scientific, industrial, and military applications require knowledge of turbulence in the Earth's atmosphere along either horizontal or vertical light paths. The turbulence causes images to blur and move. The “twinkling” of stars is a familiar example of turbulent blurring of an image as light passes through the Earth's atmosphere. Measurement of the blurring effects (called “seeing” by astronomers) provides information on how to correct for the blurring, or at least on how best to use telescopes under prevailing atmospheric conditions.

For ground-based telescopes, the turbulence-modulated refractive structure in the Earth's atmosphere integrated along the line of sight significantly blurs images, creating astronomical “seeing”. The deleterious effects in the Earth's atmosphere that create “seeing” arise from three domains distributed in altitude, the lower two of which can be directly affected or obviated by astronomers.

A useful schematic representation of the contribution of atmospheric turbulence, portrayed as the altitude-weighted refractive index structure constant, Cₙ², with height is shown in FIGS. 1A-1B (Diagram from Beckers (1993) with data from Hufnagel (1974) and Valley (1980)). The panels in FIGS. 1A-1B show atmospheric turbulence (h·Cₙ²(h)) plotted as a function of altitude for an observatory at sea level and another at 2630 meters above sea level. Surface-generated turbulence is shown as the dashed line. The middle peak, which decreases dramatically with increasing altitude, arises from the planetary boundary layer. The approximate altitude at which the planetary boundary layer turbulence contribution is equal to that typically created by a surface layer occurs at an altitude of about 2135-m. Higher observatory sites are less affected by planetary boundary layer turbulence. As noted, there are three conceptually separate physical contributions to atmospheric turbulent structure, distributed in altitude, and represented by the three peaks in FIGS. 1A-1B. FIG. 1A represents a sea level observatory and FIG. 1B represents another observatory at 2630-m altitude. There is overall less turbulence, represented as the integral of these curves, at the higher site. In particular, compare the middle peak of each panel (˜1-km altitude) and note the dramatic decrease in turbulence with increasing altitude.

The origin of these three peaks is rather intuitive. The lowest altitude (leftmost) peak describes turbulence at the surface corresponding to the interaction of the surface winds with terrain, vegetation, and buildings. This layer is referred to as the surface layer. Clearly, observatory site selection and the design and distribution of buildings can minimize the detrimental effects of the surface layer. Sites which are aerodynamically “cleaner” allow more laminar airflow, resulting in decreased surface layer turbulence.

The middle peak in FIGS. 1A-1B corresponds to the planetary boundary layer and is the result of large-scale interactions of the Earth's air mass with, for example, continents and mountain ranges. In general, selecting a higher observatory site can obviate the vast majority of this component of turbulence, and this is the reason most modern observatories are located on mountain tops.

The third component of turbulence occurs at an altitude above 10-km, far above terrestrial observatory sites. Observatory site selection cannot really help mitigate this turbulence, though techniques such as adaptive optics can help correct for its blurring effects.

It is clear that the surface layer and the planetary boundary layer turbulence can be minimized by observatory site selection and intelligent development of the site. Further, continuous “seeing” measurements during telescope operation allow more robust choice of queued observing programs, for example.

A major fraction of the atmosphere's degrading effects arise from turbulence induced in the surface layer of the atmosphere, that boundary layer within about 30-m of the ground where terrain, vegetation, structures, and the Earth's thermal effects principally create turbulence. For many applications, such as the exact placement of a new telescope, finding a location where the surface layer turbulence is a minimum under prevailing wind conditions is very important. Similarly, knowing how high above grade to raise a telescope to ensure it is above surface layer turbulence adds to its effectiveness, as does understanding the impacts of the telescope structure and enclosure on its imaging capability. Thus, long-term independent measurement of the surface layer turbulence, independently of the total turbulence throughout the atmosphere, is highly desirable.

Differential image motion measurement (DIMM) is an accepted technique for measuring the magnitude of atmospheric turbulence at astronomical observatories. The concept relies on a single telescope with two sub-apertures. Wedge prisms on one or both sub-apertures create optical paths slightly offset in angular alignment one relative to the other in the telescope. A single star is imaged by the system onto a high speed imaging device such as a CCD or CMOS camera. With the two slightly offset images, the system results in two images of the star, each made through a separate small tube of atmosphere. The “tubes” are parallel to each other through the atmosphere. By monitoring the time dependent differential motion of the two star images one relative to another, astronomers can measure the local “seeing” conditions.

Classical DIMM uses a single telescope fitted with two diametrically separated sub-apertures that are illuminated by a distant star. The optical wavefront from the star, which appears as a true point source, is plane parallel. The two optical paths created by the two sub-apertures result in two images in the focal plane, in which is located a rapid readout area-format detector. The two images move rapidly with respect to each other on the detector, even though they are created by the same source, because the two images result from two separate optical paths through the atmosphere. Because the turbulence-induced index of refraction varies separately for the two images, measuring their relative motion is a measurement of the turbulence on a spatial scale determined by the spacing between the sub-apertures, and on a time scale set by the integration time of the DIMM camera, typically 100-1000 frames per second. Because the DIMM technique measures a star, it measures the turbulence throughout the entire atmosphere.

Most of the atmosphere's degrading effects are believed to result from turbulence in the boundary layer, that layer of air within approximately 30-m of the ground. To locate a telescope facility at the best possible location, it is important to measure the “seeing” not only for the entire atmosphere but to measure specifically the impact of the surface layer. Unfortunately, because they are integral techniques, the conventional or standard DIMM techniques do not make specific surface layer measurements.

References in the area related to the effects of turbulence in the atmosphere to astronomical studies include the following:

Bally, J. Theil, D., Billawalla, Y., Potter, D., Loewenstein, R. F., Mrazek, F., & Lloyd, J. P., Publications of the Astronomical Society of Australia, 13, 22, 1996.

Beckers, J. M., “Adaptive Optics for Astronomy: Principles, Performance, and Applications,” Ann. Rev. Astron. Asterphys., 31, 13, 1993.

Martin, H. M., PASP, 99, 1360, 1987.

Sarazin, M. and Roddier, F., A&A, 227, 294, 1990.

Stock, J. and Keller, G., Astronomical Seeing in Telescopes—Volume I of Stars and Stellar System, eds. Kuiper and Middlehurst, University of Chicago Press, Chicago 1960.

Hufnagel, R. E., Digest of Technical Papers, Topical Meeting on Optical Propagation through Turbulence, University of Chicago, Boulder, Chicago, July 9-11, Paper Wal, 1974.

Valley, G. C., Appl. Optics, 19, 574, 1980.

Tatarski, V. I., Wave Propagation in a Turbulent Medium, McGraw-Hill, New York; 1961.

Fried, D. L., J. Opt. Soc. Am., 55, 1427, 1965.

### BRIEF DESCRIPTION OF THE DRAWINGS

Embodiments, aspects, advantages, and features of the present invention will be set forth in part in the description that follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in these embodiments and their equivalents.

FIGS. 1A-1B show atmospheric turbulence (h·Cₙ²(h)) plotted as a function of altitude for an observatory at sea level and another at 2630 meters above sea level.

FIG. 2A depicts a block diagram of an embodiment of an apparatus having a plurality of sources, a collector, and an analyzer, in accordance with the teachings of the present invention.

FIG. 2B depicts a SDIMM schematic for a plurality of sources, in accordance with the teachings of the present invention.

FIG. 3A depicts a block diagram of an embodiment for an apparatus including a transmitter having multiple light sources, a receiver having a number of light detectors, and an analyzer, in accordance with the teachings of the present invention.

FIG. 3B illustrates an embodiment for a SDIMM schematic for multiple sources and aperture masks, in accordance with the teachings of the present invention.

FIG. 4A depicts an embodiment of a schematic layout of a SDIMM system having two sources and two receiving sub-apertures providing images, in accordance with the teachings of the present invention.

FIG. 4B illustrates an embodiment of a SDIMM schematic for two sources and two sub-apertures, in accordance with the teachings of the present invention.

FIG. 5 depicts an embodiment of an independent point-like source, in accordance with the teachings of the present invention.

FIGS. 6A, 6B show a schematic of an embodiment for a two-source SDIMM transmitter, incorporating two independent point-like sources as depicted in FIG. 5, in accordance with the teachings of the present invention.

FIGS. 7A, 7B depict an embodiment of a multi-aperture mask incorporating two sub-apertures and beam steering using ganged rotating wedge prisms, in accordance with the teachings of the present invention.

FIG. 8 shows a schematic embodiment of images created with a two-source SDIMM, in accordance with the teachings of the present invention.

FIG. 9 illustrates an embodiment using microthermal sensors suspended above a modified DIMM apparatus in which the microthermal sensors function as microthermal probes or sources, in accordance with the teachings of the present invention.

FIG. 10 illustrates a sample of microthermal measurements of an atmospheric neutral event acquired during the neutral event at different attitudes in an embodiment of a test using the embodiment for a set-up shown in FIG. 9, in accordance with the teachings of the present invention.

FIG. 11 shows “seeing” measurements taken simultaneously with the microthermal measurements in the embodiment of FIG. 10, in accordance with the teachings of the present invention.

FIG. 12 illustrates data from an embodiment of a laboratory test of two SDIMM systems observing the same pair of sources at a distance of 35-m from a receiver, in accordance with the teachings of the present invention.

FIG. 13 depicts a schematic of an embodiment of a SDIMM system, in accordance with the teachings of the present invention.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense.

The term, ro, referred to herein is Fried's (Fried 1965) parameter, which is the statistical diameter over which the wavefront remains phase coherent after passing through a turbulent medium, such as the atmosphere. Thus, for example, a telescope smaller than r₀ will produce a diffraction limited image because the wavefront entering the telescope is phase coherent. Telescopes larger than r₀ will exhibit seeing-blurred images, because multiple phase coherent patches are present at the aperture. Each r₀ patch is not phase coherent with its neighbors at the aperture. Adaptive optics work by “correcting” the phase of the multiple r₀ patches to achieve phase coherence over much larger fractions of the aperture, thus creating sharper images that approach the diffraction limit. In various embodiments described herein, the size of sub-apertures may be smaller than r₀.

Turbulence in the atmospheric surface layer is a significant contributor to the astronomical “seeing” and image motion that degrades the image quality of ground-based telescopes. The surface layer of the atmosphere is that portion of the atmosphere about which one can do something: telescopes can be located on sites that minimize surface-induced turbulence, they can be elevated to minimize the lowest level of the surface layer dominated by Earth's thermal environment, and decisions about investment and techniques for adaptive optics can be intelligently made. Understanding the surface layer, which is subjected to small-scale (≦1-km) horizontal and vertical spatial variations dependent upon wind speed and direction, natural topography and orography, buildings and ground cover, is key to choosing sites for new telescopes and for optimizing the utility of existing telescopes.

Turbulence in the atmospheric surface layer is a significant contributor to the astronomical image quality and image motion that degrades the efficiency of ground-based telescopes, which necessarily look up through the entire overlying atmosphere. Horizontal paths experience even greater image, wavefront and information degradation due to atmospheric turbulence. Optically detected turbulence can indicate large-scale organized mechanical turbulence, such as wind shear and aircraft wake turbulence.

Because the surface layer of the atmosphere is that portion of the atmosphere about which one can do something, understanding the surface layer, which is subject to small-scale (≦1-km) horizontal and vertical spatial variations dependent upon wind speed and direction, natural topography and orography, buildings and ground cover, is key to many practical applications. Typical applications include choosing sites for new telescopes and for optimizing the utility of existing telescopes, for laser-based communications and energy delivery on horizontal scales of approximately a kilometer, and detection of potentially hazardous atmospheric turbulence at and near airports.

In an embodiment, an apparatus or a system herein referred to as Surface Layer Atmospheric Turbulence Differential Image Motion Measurement (SLAT-DIMM, contracted to SDIMM, used hereafter) apparatus and/or system is designed to quantify optical refractive turbulent power over horizontal and/or vertical paths in the surface layer. It can help make “visible” organized turbulence at sites on the scale of airports.

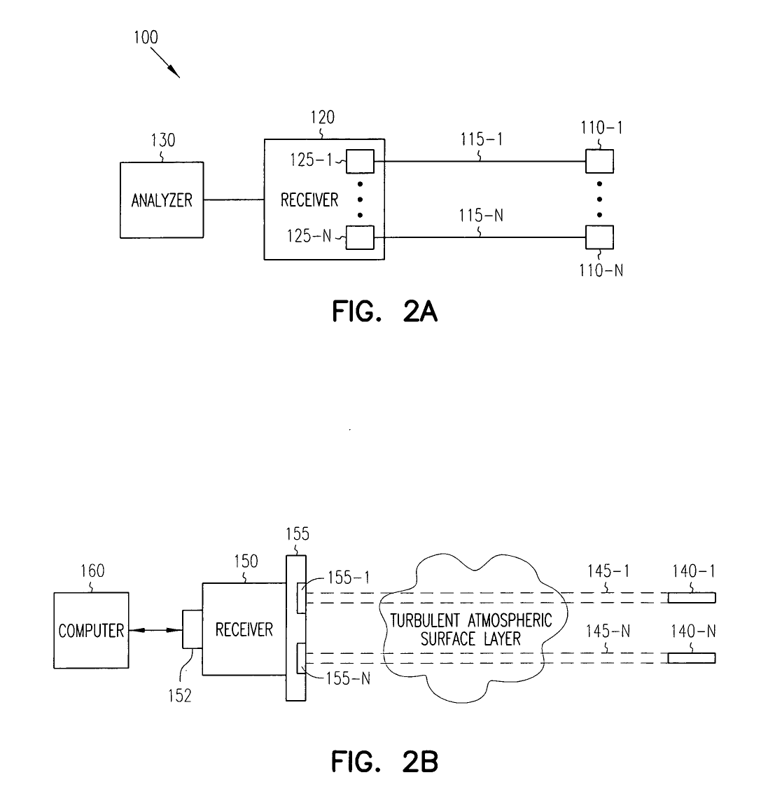

FIG. 2A depicts a block diagram of an embodiment for an apparatus 100 having a plurality of sources 110-1 . . . 110-N, a receiver 120 or collector 120, and an analyzer 130. Each source 110-1 . . . 110-N transmits energy to collector 120 along different paths 115-1 . . . 115-N. Analyzer 130 is configured to determine surface layer atmospheric turbulence based on perturbations along different paths 115-1 . . . 115-N traveled to collector 120 by the energy from each source 110-1 . . . 110-N relative to each other. In an embodiment, collector 120 includes a number of sub-apertures 125-1 . . . 125-N, where the number of sub-apertures is substantially equal to the plurality of sources. Each sub-aperture corresponds to a separate detector to collect energy from its corresponding source. The number and geometric arrangement, including the spacing between sub-apertures 125-1 . . . 125-N, matches the geometry of sources 110-1 . . . 110-N. In an embodiment, apparatus 100 is a system to vertically measure surface layer atmospheric turbulence. In an embodiment, apparatus 100 is a system to horizontally measure surface layer atmospheric turbulence. In an embodiment, apparatus 100 is a system to vertically measure wind shears. In an embodiment, apparatus 100 is a system to horizontally measure wind shears. With apparatus 100 configured to measure wind shears, system 100 has application for providing flight information at airports.

FIG. 2B illustrates an embodiment for a SDIMM schematic for a plurality of quasi-point sources 140-1 . . . 140-N. SDIMM estimates the refractive power introduced into a beam by measuring the relative displacement of images of plural (point) sources placed at a defined distance from a receiver 150. In an embodiment, the defined distance is approximately 30 meters. Receiver 150 may be realized as a telescope 150 having a fast-framing camera 152. Independent optical paths 145-1 . . . 145-N are created by matching every source 140-1 . . . 140-N with a sub-aperture 155-1 . . . 155-N contained in the multi-aperture mask 155. The spacing and orientation of sources is matched by the receiver sub-aperture mask set. Data may be analyzed by a computer 160 coupled to receiver 150.

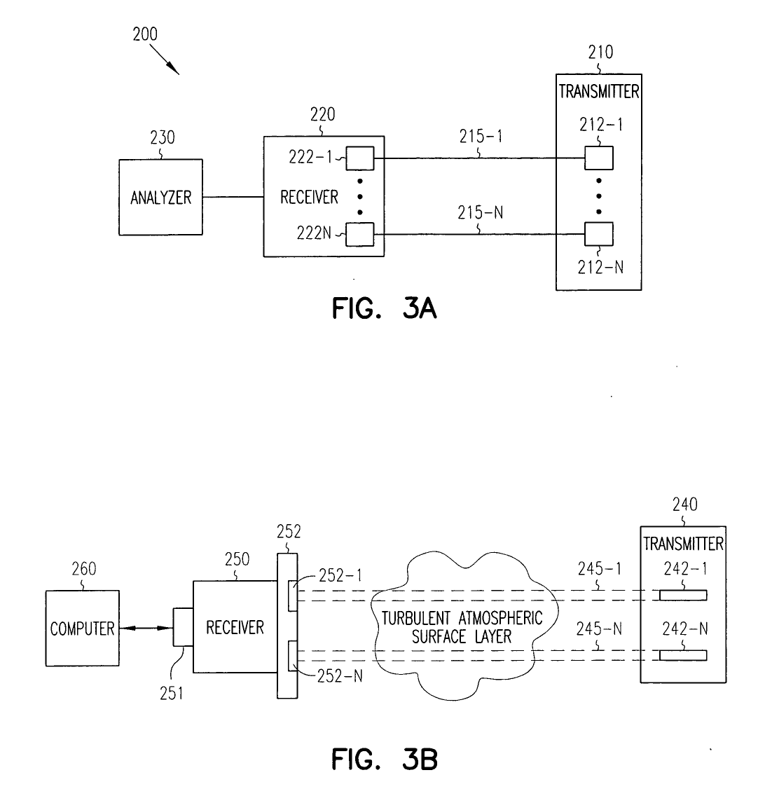

FIG. 3A depicts a block diagram of an embodiment for an apparatus 200 including a transmitter 210 having multiple optical sources 212-1 . . . 212-N, a receiver 220 having a number of optical detectors 222-1 . . . 222-N, and an analyzer 230 to determine surface layer atmospheric turbulence based on differences in energy traveling from transmitter 210 over different optical paths 215-1 . . . 215-N to receiver 220, where one optical path 215-1 . . . 215-N is traveled per optical source.

In an embodiment, receiver 220 includes a number of sub-apertures correlated to light detectors 222-1 . . . 222-N, where the number of sub-apertures and light detectors 222-1 . . . 222-N equals the number of light sources of transmitter 2210. Each sub-aperture light detector 222-1 . . . 222-N has a geometric arrangement, including the spacing between sub-apertures (hence, light detectors 222-1 . . . 222-N) matching the geometric arrangement of the light sources 212-1 . . . 212-N of transmitter 210. In an embodiment, multiple light sources 212-1 . . . 212-N are incoherent light sources. Bright incoherent light sources may be implemented to insure sufficient signal from these light sources, where a signal can be taken to be the imaging of the light source collected by analyzer 230. In an embodiment multiple light sources 212-1 . . . 212-N are multiple light emitting diodes (LEDs).

In an embodiment, analyzer 230 is arranged to analyze images collected that approximately represent point-like images. The point-like images are provided by adapting transmitter 210 to have a configuration including negative optics arranged to minify the multiple light sources 212-1 . . . 212-N to produce point-like images from each source 212-1 . . . 212-N. Optical paths 215-1 . . . 215-N from the point-like sources 212-1 . . . 212-N are distinct paths through the atmosphere that are akin to different tubes of material (tubes of different atmospheric properties).

Various embodiments of apparatus 200 can be realized for a system arranged in different configurations. Transmitter 210 and receiver 220 may be arranged such that each optical path 215-1 . . . 215-N from transmitter 210 to receiver 220 is substantially vertical through a surface layer of the atmosphere. Alternately, transmitter 210 and receiver 220 may be arranged such that each optical path 215-1 . . . 215-N from transmitter 210 to receiver 220 is substantially horizontal through a surface layer of the atmosphere. In an embodiment, system 200 includes light detectors 222-1 . . . 222-N adapted to place an array of source images on an area-format detector array. In various embodiments, analyzer 230 is adapted to derive turbulent refractive power by correlating differential image motions over spatial baselines. The spatial baselines provided by the spacing of light detectors 222-1 . . . 222-N correlated to the spacing of light sources 212-1 . . . 212-N. In various embodiments, analyzer 230 is adapted to capture images from the number of light detectors 222-1 . . . 222-N, calculate image centroids, where a centroid is a statistical center, of the captured images in real-time, and store the image centroids. These images may be point-like images. Analyzer 230 may also be adapted to analyze the stored images including averaging, root mean square calculations, power spectral analysis, cross-correlation analysis, auto-correlation analysis, and other calculations related to derivation of turbulent refractive power.

FIG. 3B illustrates an embodiment for a SDIMM schematic for multiple sources 242-1 . . . 242-N of a transmitter 240 and apertures 252-1 . . . 252-N. SDIMM estimates the refractive power introduced into a beam by measuring the relative displacement of images of multiple (quasi-point) sources 242-1 . . . 242-N placed at a defined distance from the receiver 250. In an embodiment, the defined distance is approximately 30 meters. Receiver 250 may be realized as a telescope 250 having a fast-framing camera 251. Independent optical paths 245-1 . . . 245-N are created by matching every source 242-1 . . . 242-N in the transmitter 242 with a sub-aperture 252-1 . . . 252-N contained in the multi-aperture mask 252. The spacing and orientation of sources is matched by the receiver sub-aperture mask set. Data may be analyzed by a computer 260 coupled to receiver 250.

The apparatus, or device, 100 of FIG. 2A or apparatus, or device, 200 of FIG. 3A quantitatively measures the turbulence-induced refractive power along a well-defined line of sight through the atmosphere. Such apparatus are embodiments of a Surface Layer Atmospheric Turbulence Differential Image Motion Measurement apparatus as referred to herein. In an embodiment, SDIMM may be applied for measuring the magnitude of atmospheric turbulence at astronomical observatories and other sites. In such applications SDIMM provides a different set of apparatus and methods of application to those techniques previously used in general differential image motion measurements. Other embodiments for application of SDIMM, in which optical atmospheric propagation measurements are useful, include detection and avoidance of aircraft wake turbulence.

In various embodiments, SDIMM solves problems dealing with boundary layer measurements that are not addressed by conventional DIMM technique. In an embodiment, a SDIMM can be configured to use a DIMM telescope modified with sub-apertures matched by a source unit that includes incoherent quasi-point sources separated in the same pattern and at the same spacing as the sub-apertures constructed in the DIMM telescope. A sub-aperture of a telescope may be created by fully masking the aperture of the telescope, and then creating a smaller opening in the mask. For example, a 10-inch (25.4-cm) diameter telescope may be used as a receiver. The full aperture is covered, except for two 5-cm diameter circular openings. The small circular openings are the sub-apertures. In various embodiments, sub-apertures are used to help define an optical path through the atmosphere. The source unit is situated at some defined distance from the modified DIMM telescope over which optical path turbulence can be measured. For an embodiment in which a site survey for placing an astronomical telescope is being conducted, the source unit may be suspended a distance above the ground, as high as 100-feet for example. By rapidly interrogating the camera associated with the DIMM telescope, the differential motion of the sources on the image plane can be tracked, providing a reliable and direct measurement of surface layer atmospheric turbulence.

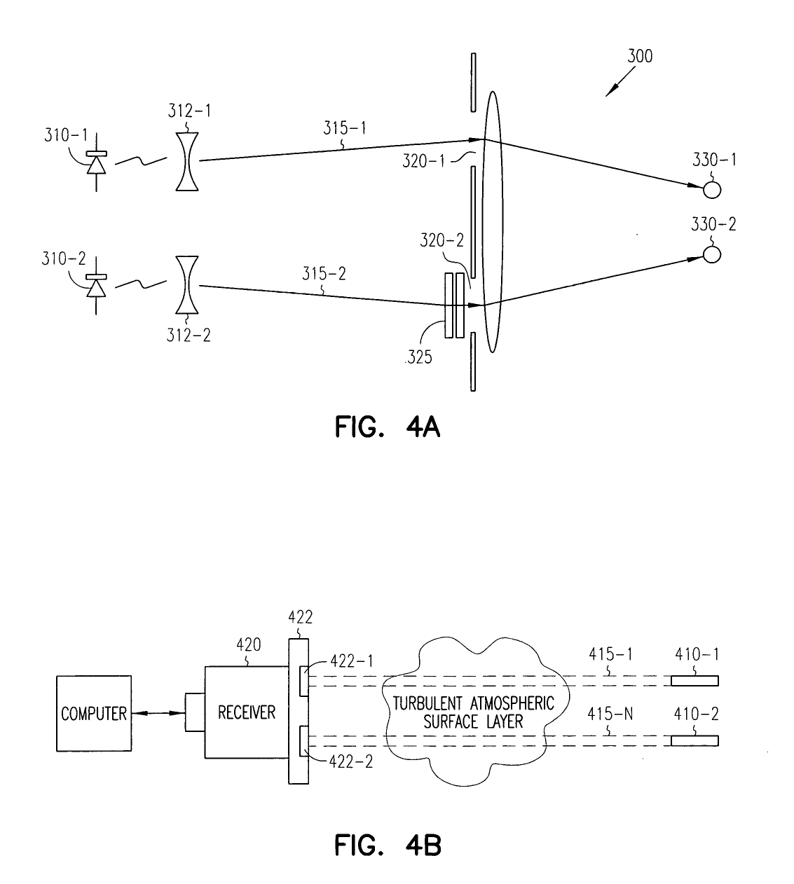

FIG. 4A depicts an embodiment of a schematic layout of a SDIMM system 300 having two sources 310-1, 310-2 and two receiving sub-apertures 320-1, 320-2 providing images 330-1 and 330-2. Sub-apertures 320-1, 320-2 are provided in a receiving device to capture light from sources 310-1, 310-2 traveling along two independent optical paths 315-1 and 315-2, respectively, to ultimately provide images 330-1 and 330-2. Sub-apertures 320-1, 320-2 may be realized as two sub-apertures in a telescope. In an embodiment, sub-apertures 320-1, 320-2 may be realized as two sub-apertures in a reflecting telescope. The differential motion of the two images 330-1, 330-2 provides a direct measure of atmospheric turbulence. The SDIMM apparatus and technique provide for application of DIMM techniques to surface layer characterization previously not possible.

The use of multiple sources produces independent optical paths through the atmosphere. In an embodiment, using two sources may simulate twin optical paths through the atmosphere. In an embodiment, constructing the SDIMM system 300 with high brightness LEDs as sources 310-1, 310-2 and negative lenses 312-1, 312-2 provides incoherent artificial sources of sufficient brightness and small enough angular extent to act as point-like sources or to simulate stars. In an embodiment, use of paired optical wedges 325 to alter the angular axis of one beam relative to the other gives appropriately spaced separate images on a focal plane such as a camera detector. The paired optical wedge technique results in four images on the focal plane rather than the two from conventional DIMM measurements. Care should be taken to select the correct image pairs for measurement and analysis. An embodiment includes two ganged rotating wedges 325 on one sub-aperture instead of the single wedge used in the classical DIMM system. Alternate techniques for eliminating the extra image pair may include such techniques as polarization and color masking.

In an embodiment, images 330-1, 330-2 are captured using a high-speed CMOS camera to monitor and measure the differential motion of image points. Sub-frame windowing may be used to improve frame rate. The images captured can be furthered processed with custom software, including real-time image spot centroiding. In an embodiment, a CCD or other area-format imaging detector may be used to capture images.

In an embodiment, a combination of multiple sources, low altitude deployment such as surface layer deployment, negative lenses at each of the sources, and generating multiple optical paths at slightly different angles through a collection apparatus such as a telescope to produce multiple, steerable images results in a new technique that images separate sources through separate tubes of air, allowing examination of the differential characteristics of one air tube relative to the other. In an embodiment, a SDIMM technique has application to boundary layer measurements such as surface layer measurements. The surface layer measurements may be performed for a vertical arrangement through a surface layer. The surface layer measurements may also be performed for a horizontal arrangement through a surface layer providing horizontal path characterization of the boundary layer. In an embodiment, the horizontal path characterization provides a characterization that is substantially horizontal only. In an embodiment, the angle of the measured path may be at any angle from horizontal through vertical. An embodiment of the technique may be applied at any desired distance, provided sufficiently bright sources are available. Embodiments for horizontal applications include measurement of wake turbulence generated by aircraft take-off and landing.

In embodiments for astronomical (and other) applications, a SDIMM operated simultaneously with a classical DIMM device allows scientists to determine the source of the greatest turbulence at a given time: the surface layer or the higher altitudes, typically associated with the jet stream. This technique or method allows optimization of telescope use, or, if the turbulence is local, allows real-time modification of enclosures and structures to minimize the surface layer turbulence.

In an embodiment, a SDIMM technique provides for the observation of the optical effects of building heat sources, including heaters, electrical apparatus, and any other apparatus or natural source that generates heat. Other embodiments include using a SDIMM system horizontally in the free atmosphere to measure the cooling of nearby buildings just after sunset, and the passage of vehicles on a busy street.

In an embodiment, a two source SDIMM approach uses two closely spaced optical sources mounted to a tower and suspended above the ground. In an embodiment, the two closely spaced optical sources are suspended at about 100 feet above ground. A telescope with two optical paths, one offset slightly in angle relative to the other, may be used to image the sources onto a focal plane. By rapidly interrogating a camera receiving these images, one can track the differential motion of the two sources on the image plane, thereby providing a reliable and direct measure of surface boundary layer atmospheric turbulence.

Unlike full atmospheric DIMM which uses a single source (star) to measure two columns of air resulting in two distinct images on the focal plane, an embodiment of a SDIMM technique uses two sources resulting in four images on the focal plane. Care is taken to select the correct two images as there are four possible optical paths. In an embodiment, two of the four possible optical paths are of interest. In alternate embodiments, various combinations of these four possible optical paths are anticipated to be used. In embodiments selecting two images, blocking of the two unwanted paths is possible in a number of ways. In an embodiment, a combination of narrow optical wedges on one sub-aperture of a telescope is used to slightly offset one image pair relative to the other, and, then, the two desired spots are selected and monitored. An alternate approach includes equipping each source and each aperture with linear polarizers. In such an arrangement, P polarization from one source can pass through an aperture accepting P polarization but will be blocked from the other aperture looking for S polarization. Light may be lost in this alternate embodiment, reducing the dynamic range of the instrument or decreasing frame rate. In an embodiment, optical sources of slightly different wavelength are used along with narrow-band optical filters on each sub-aperture of a light receiver such as a telescope. In this manner, only light of the correct wavelength (color) is accepted by each sub-aperture.

FIG. 4B illustrates an embodiment of a SDIMM schematic for two sources 410-1, 410-2 and two sub-aperture masks 422-1, 422-2. SDIMM estimates the refractive power introduced into a beam by measuring the relative displacement of images of two (point) sources placed at a defined distance from receiver 420. Independent optical paths 415-1, 415-2 are created by matching both sources with a sub-aperture contained in the two-aperture mask 422. The spacing and orientation of sources is matched by the receiver sub-aperture mask set.

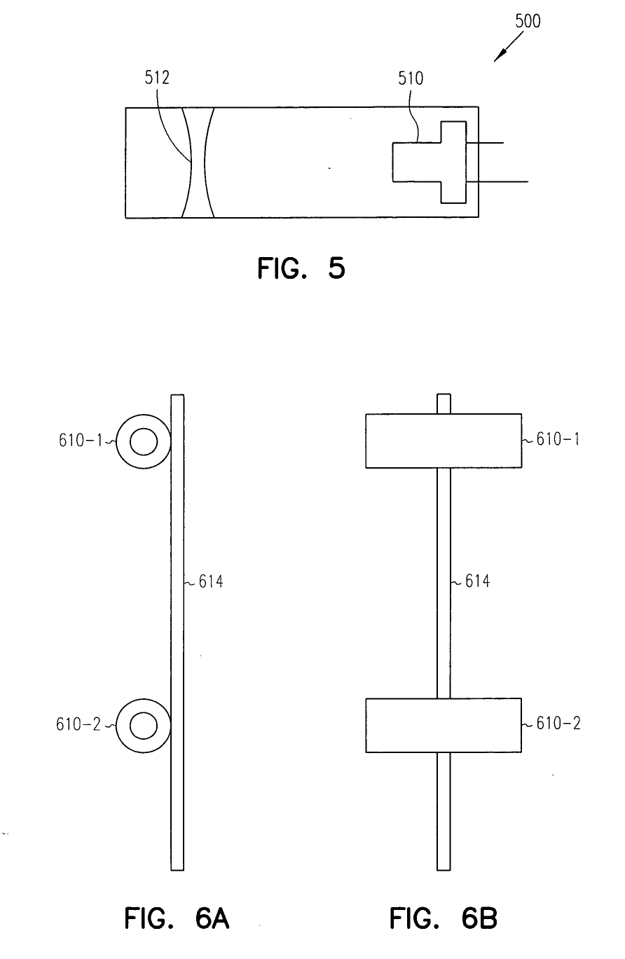

FIG. 5 depicts an embodiment of an independent point-like source illustrating an embodiment of a single source 500. Multiple of these sources corresponding to multiple apertures at the receiver may be combined or grouped to form a SDIMM transmitter. An embodiment of a source incorporates an LED 510 to provide incoherent radiation. Each LED may be a superbright LED minified by a negative optic 512. In an embodiment, negative optics are used to minify the source, making it appear at a distance from the receiver greater than it actually is, and allowing the receiver to detect it as a point source.

FIGS. 6A, 6B represent an embodiment of a two-source transmitter. FIG. 6A is an on-axis view and FIG. 6B is a lateral view. In an embodiment, individual sources 610-1, 610-2 are attached to a structure 614 to ensure independent optical paths to a like number of sub-apertures at the receiver. In an embodiment, the structure is made to be small, with low cross-section to wind loading. In an embodiment, the source assembly is an array of individual sensors arranged on a framework to provide variable spacing. The spacing and orientation of the source assembly is matched by the sub-apertures in the multi-aperture mask. This ensures independent, equally spaced optical paths through the surface layer. The source assembly is designed for small cross section to minimize wind loading.

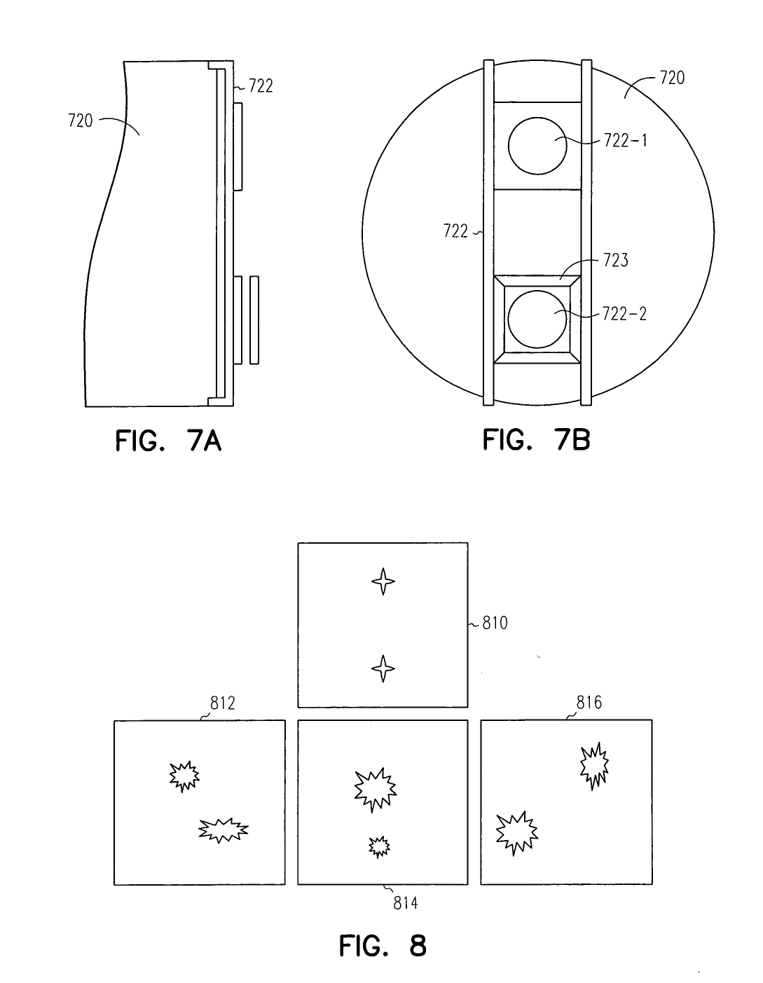

FIGS. 7A, 7B depict an embodiment of a multi-aperture mask incorporating two sub-apertures, and illustrate an embodiment of beam steering using ganged rotating wedge prisms. FIGS. 7A, 7B show a receiver 720 configured as a masked single telescope. In an embodiment, two sub-apertures 722-1, 722-2, each smaller than the coherence scale in the atmosphere (r₀), are embedded in the full aperture mask 722. In an embodiment, light passing through one or both sub-apertures is directed onto the area-format detector in the focal plane of the telescope by ganged beam steering prisms 723. In an embodiment, the sub-apertures can be adjusted in center-to-center spacing by a mechanism. In an embodiment, adjustment of sub-aperture spacing allows applying the SDIMM technique on differing spatial scales, thus yielding additional information about atmospheric turbulence over the optical path length. In an embodiment, a telescope simultaneously forms an image of each point source, where the aperture is masked, except for open (˜5-cm diameter) sub-apertures.

FIG. 8 shows a schematic embodiment of area-format data acquired by a receiver of images created with a two-source SDIMM. With no atmospheric turbulence, each sub-aperture forms an image (nominal image with no turbulence) of its corresponding quasi-point source, as illustrated in the top panel 810, where the upper image corresponds to the nominal position of images with no turbulence affecting their positions. In an embodiment, a time series of measurements of turbulence-blurred images 812, 814, 816 is acquired by SDIMM, which represent a time series of exposures showing image motion. The centroid-to-centroid spacing of these images provides the raw data for SDIMM. The centroid of each image is the intensity-weighted position on the area-format detector, measured in pixel units. In an embodiment, the spacing between two images is measured and analyzed. In an embodiment, the centroid-to-centroid spacing between every independent image pair is analyzed to evaluate atmospheric turbulent power along the optical path. As noted FIG. 8 illustrates schematic data frames. Centroids of turbulence-blurred point-source images are displaced by turbulence-induced refractive power. The separation of images is the basic data analyzed by the SDIMM computer to characterize the turbulence along the optical path. In an embodiment, frames 812, 814, 816 are acquired at a rate of approximately 250 Hz, effectively “freezing” the image centroids.

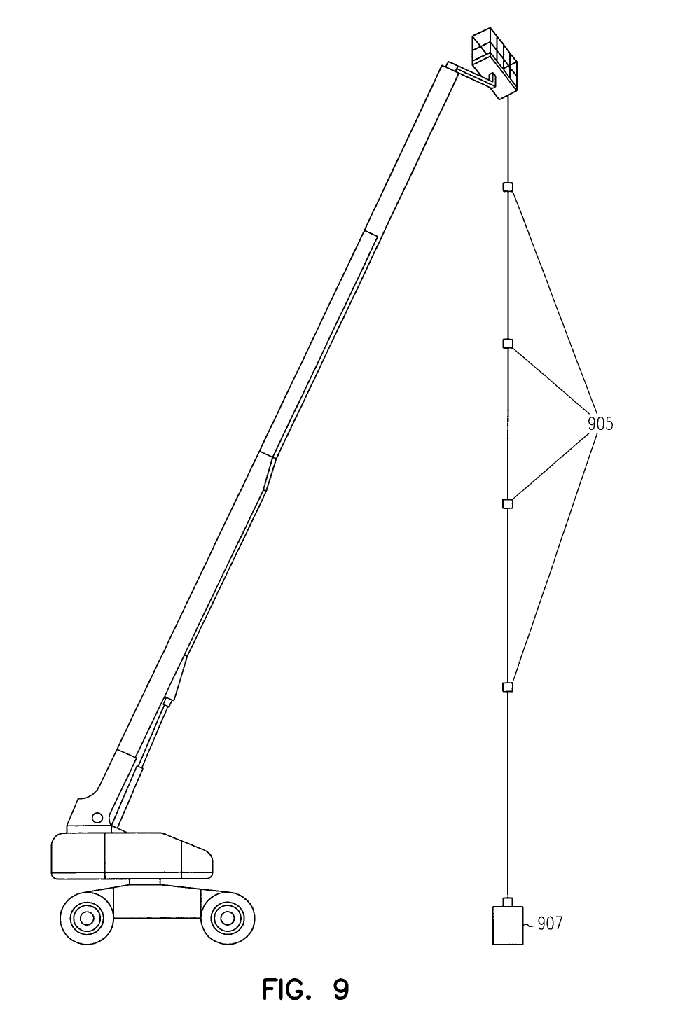

Embodiments of other techniques may be employed to measure parameters or properties in the surface layer. FIG. 9 illustrates an embodiment using microthermal sensors 905 suspended above a modified DIMM apparatus 907 in which the microthermal sensors function as microthermal probes or sources. In the embodiment of FIG. 9, pairs of conventional four watt nightlight bulbs are used as temperature probes spaced 1-m apart and suspended at various altitudes from near ground level to 30-m to an approximate height of 30-m (˜100-feet) with vertical extent provided by a hydraulic lift. The resistance of the tungsten filament of the nightlight bulbs being very sensitive to temperature and their low thermal mass yield short thermal time constant (<10-ms). The difference in resistance between a pair of probes at the same altitude is measured with a balanced bridge circuit at 250-Hz and converted to temperature difference. Root mean square (RMS) temperature difference can be converted to Cₙ² if a Kolmogorov spectrum is assumed,
Cₙ²=((7.9×10⁻⁵P)/T²)²·((<ΔT²>−<ΔT>²)r^{2/3}),
where P is the pressure in millibars, T is in Kelvin, and r is the separation of the probes in meters. Integrating Cₙ²(h) provides the r₀ contribution from surface layer.

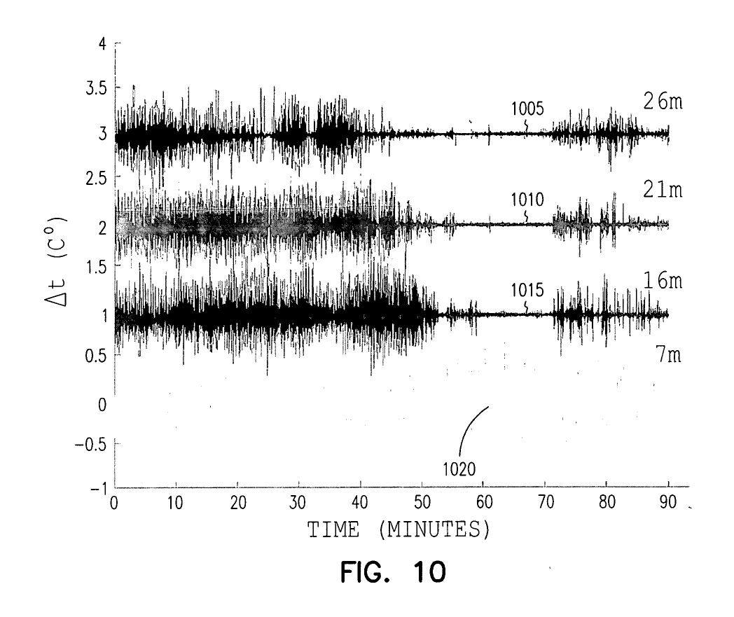

FIG. 10 illustrates a sample of microthermal measurements 1005, 1010, 1015, 1020 of an atmospheric neutral event acquired during the neutral event at different attitudes in an embodiment of a test using the set-up of FIG. 9. Neutral events occur just before dusk and after dawn when the solar heating of the atmosphere balances terrestrial heating. The resulting temperature gradient is shallow and inhibits turbulent mixing. In FIG. 10, the temperature difference between two probes spaced by 1-m and sampled at 250-Hz is plotted vs time. These events are representative of the optimum surface layer conditions for a particular site. The quiescent portion of the atmosphere during a neutral event does not extend all the way to the ground, 1020, as shown in FIG. 10. The lowest level of the atmosphere, <10-m, becomes more turbulent.

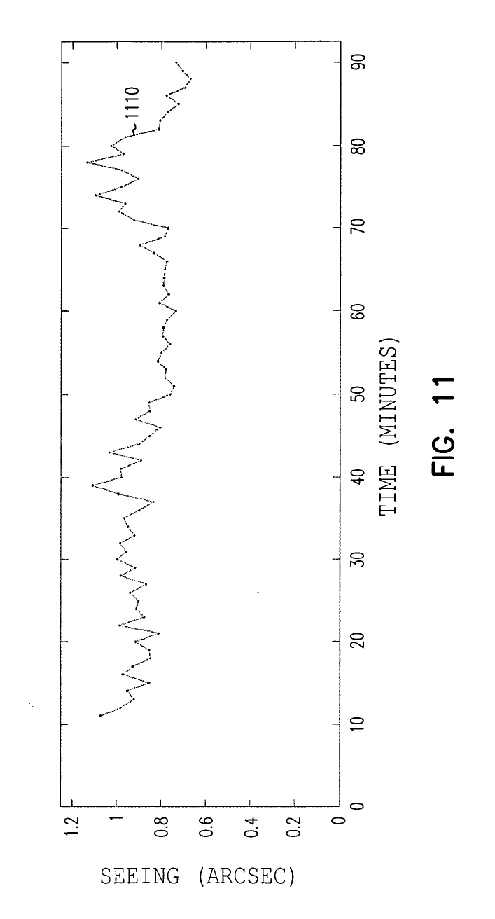

In an embodiment, FIG. 11 shows “seeing” measurements 1110 taken simultaneously with the microthermal measurements in FIG. 10. Full-atmosphere DIMM measurements 1110 for “seeing” at the same location and time as FIG. 10 were made. A decrease of 0.1-0.2″ in the mean “seeing” coincides with the neutral event. During the neutral event, the median “seeing” falls from 0.9″ to 0.8″. At this site, elevating a telescope 10 m could improve the median “seeing” by >0.1″ during the best “seeing” conditions.

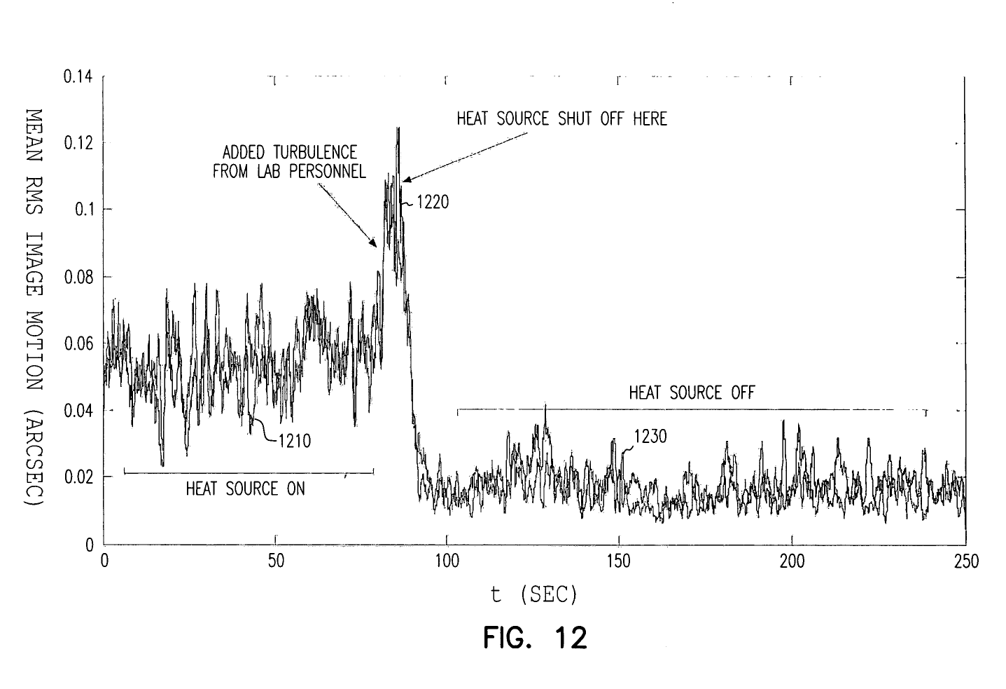

FIG. 12 illustrates data from an embodiment of a laboratory test of two SDIMM systems observing the same pair of sources at 35-m. First, a 1.5-kW heat source is provided in front of them. The heat source is turned off after 90 seconds and subsequent differential image motion is lessened. The data of FIG. 12 is from a test in a relatively controlled laboratory environment. FIG. 12 shows a sample of differential image motion measurements in a lab, starting start with a 1.5-kW heat source in front of the LED sources 1210, turning it off 1220, and observing the turbulence drop as the air in the lab returns to its nominal turbulent level 1230, where image motion is dominated by centroid noise.

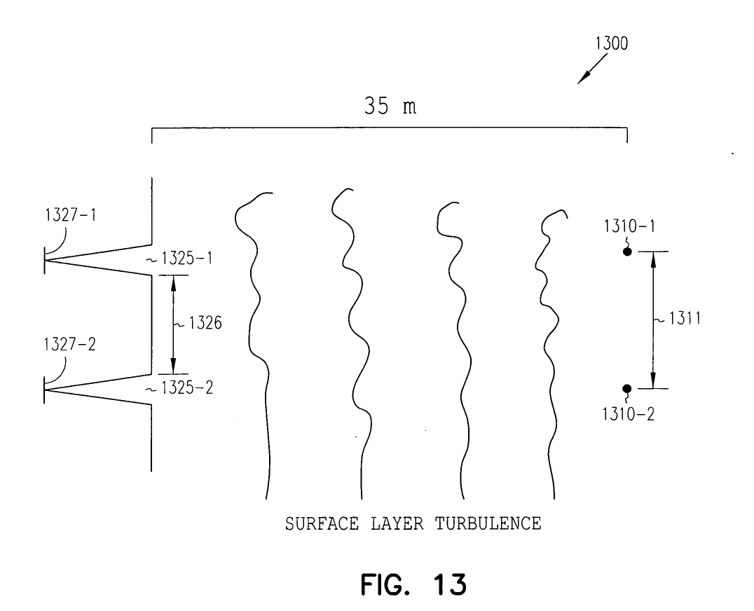

FIG. 13 is a schematic of an embodiment of a SDIMM system 1300. A pair of LEDs 1310-1, 1310-2 separated by a distance 1311 of about 20-cm and suspended 35-m above the ground is imaged by two 5-cm sub-apertures 1325-1, 1325-2, separated by a distance 1326 also of about 20-cm, mounted to a 10-inch telescope. Turbulence in the air between the LEDs and telescope causes the images 1327-1, 1327-2 of the LEDs to move relative to one another. Microthermal measurements, while measuring the vertical structure of the surface layer, do so only at one spatial scale. In an embodiment, a system measures the integrated contributions of surface layer turbulence to “seeing.” To sample only the surface layer but maintain full path optical sampling, a target star normally observed with a DIMM telescope is replaced with a pair of LEDs, separated by 20-cm at the top of a 30-m tower. Each LED is minified by a 12-mm f/1 negative lens 10-cm, effectively creating an incoherent point source. Laser sources are not used in this embodiment since laser spots do not work due to speckle patterns. The LEDs are imaged by two 5-cm sub-apertures separated by 20-cm mounted on a 10-inch Meade LX200 with a f/6.3 focal reducer, so the full width at half maximum (FWHM) of the spot is ˜3 pixels. Spot images are separated by a pair of 5-cm wedge prisms over one aperture so that each aperture produces only an image of its corresponding source on the detector. The camera used in this embodiment is a fast-framing camera, an EPIX Silicon Video 2112 with a D2X PCI capture card. The detector is an uncooled Zoran 1288×1032 CMOS device with 6-μm pixels. The full-frame capture rate is >30-Hz, which may be quite noisy, with capture of a 1288×100 sub-frame at 270-Hz.

The acquisition and processing software is written in Microsoft Visual C++ using the EPIX software library. Images of LEDs can be marked and followed at 125 Hz with a windowed centroiding algorithm. Exposure time can be set at <4-ms to alleviate image smearing but retain a signal-to-noise ratio (S/N) of approximately 100. RMS centroiding noise of approximately 0.02 arcsecond may be obtained.

The physical effect limiting the angular resolution of telescopes to greater than the diffraction limit is the Earth's atmosphere, a refracting medium. The turbulent structure embedded in the Earth's atmosphere limits (principally) phase coherence to a small fraction of the aperture of the telescope. Further, the effects of refractive index power fluctuations in the Earth's atmosphere are important, whatever the application.

Three immensely practical considerations for astronomers are: 1) the (global) location of new observatories, 2) the location and structure of individual telescopes on new and existing observatory sites, and 3) the design and benefit-to-cost analysis of adaptive systems at a particular telescope. Better-sited telescopes with respect to minimizing “seeing” produce better and more cost-effective astronomical research. A fourth consideration is the use of continuous surface layer and total “seeing” measurements for real-time decision-making about alternative or queued observing programs.

In an embodiment, a SDIMM device includes a transmitter, a receiver, and a computer data acquisition/reduction system, with a user interface. The transmitter and receiver are spaced apart by the surface layer path length, L, to be monitored. The atmospheric optical path may, in fact, be considered an optical element in this system. By careful design of the transmitter, the receiver, and the data analysis system, a statistical characterization of the optical refractive power of the fluid atmosphere may be produced. The receiver has two or more sub-apertures of diameter, d, separated by distance, rᵢ, where i enumerates the baseline established by the separated sources. In an embodiment, the sub-apertures are circular sub-apertures. In an embodiment, the sub-apertures are approximately 5-cm in diameter separated by approximately 20-cm on a single telescope. Each sub-aperture is matched by a source at the transmitter. Thus, multiple independent, sensibly parallel optical paths are simultaneously sampled at high temporal rate to derive image data from which statistical atmospheric characterization parameters can be derived.

In an embodiment, the transmitter includes two or more super-bright light-emitting diodes (LEDs) with negative lenses to optically minify the LED source. LEDs are used because they are frequency incoherent. In an embodiment, a laser was eliminated from use as a light source for the transmitter, because a laser is frequency coherent. As a result, an image of a laser source has interference structure which significantly perturbs images at the receiver. Since the Earth's atmosphere is a refractive medium, rays through the Earth's atmosphere have different path lengths. Rays with slightly different path lengths are made to converge at the receiver to form the image that is analyzed. Due to the slight path length differences and reflection from multiple surfaces within the receiver, a laser beam will interfere with itself, and an alternating pattern of dark and light bands due to the interference are embedded in the point-like images that are to be analyzed. The presence of this interference pattern means that the statistical center (centroid) of a point-like image is different if a coherent source is used, as opposed to an incoherent source, which doesn't exhibit the interference pattern. Images formed with an incoherent source provide the correct analysis of the centroid of the images to be analyzed.

The transmitter and receiver are physically separated over the surface layer path length, L, to be analyzed and monitored. In an embodiment a telescope is used as the principal optical component of the receiver. The telescope is capable of resolving the light emitting region of an LED. In an embodiment, the image formed by the telescope is point-like. Use of a point-like object allows for the raw data derived from the system to be the centroid of one image relative to another. The theory of image moments is well developed for point images. For an embodiment using a telescope as a receiver, SDIMM data may be compared with data from a full atmospheric DIMM. The full atmosphere DIMM images a single star, which is a true point source relative to the telescopes used. Thus, SDIMM data are directly comparable to full atmosphere DIMM data if the SDIMM images are point-like.

The LED can be made to appear point-like to the telescope if the LED active area is optically made to appear at a great distance from the telescope. In an embodiment, this apparent distance is obtained by using a negative lens placed approximately 10-cm from the LED. The negative lens creates a distant virtual image of the LED source, making the LED appear as a point to the receiver, and as a result, making the LED appear to be at a great distance and thus directly comparable to a star.

Another useful and physical description is that the expanding spherical wavefront for a distant star is very nearly plane parallel when it reaches the Earth's atmosphere. The atmosphere induces wavefront perturbations in the form of refractive power. This power is measured by a full atmosphere DIMM. To provide a comparison of SDIMM data to the full atmosphere DIMM, an expanding wavefront from sources at a finite distance by using negative optics is optically created.

In addition, the plane parallel wavefront from a star uniformly illuminates the aperture and sub-apertures of the receiver. The inclusion of negative optics in an embodiment of a SDIMM transmitter more nearly replicates this condition, which largely minimizes the path position dependence of detection of turbulence, discussed below.

In an embodiment, the atmospheric optical path may be considered an optical element in a SDIMM apparatus or system. The atmosphere is a turbulent refractive medium, and it is the power of the refractive turbulence over a finite path length that is measured by a SDIMM apparatus or system. This path length can be horizontal, vertical, or at any angle between.

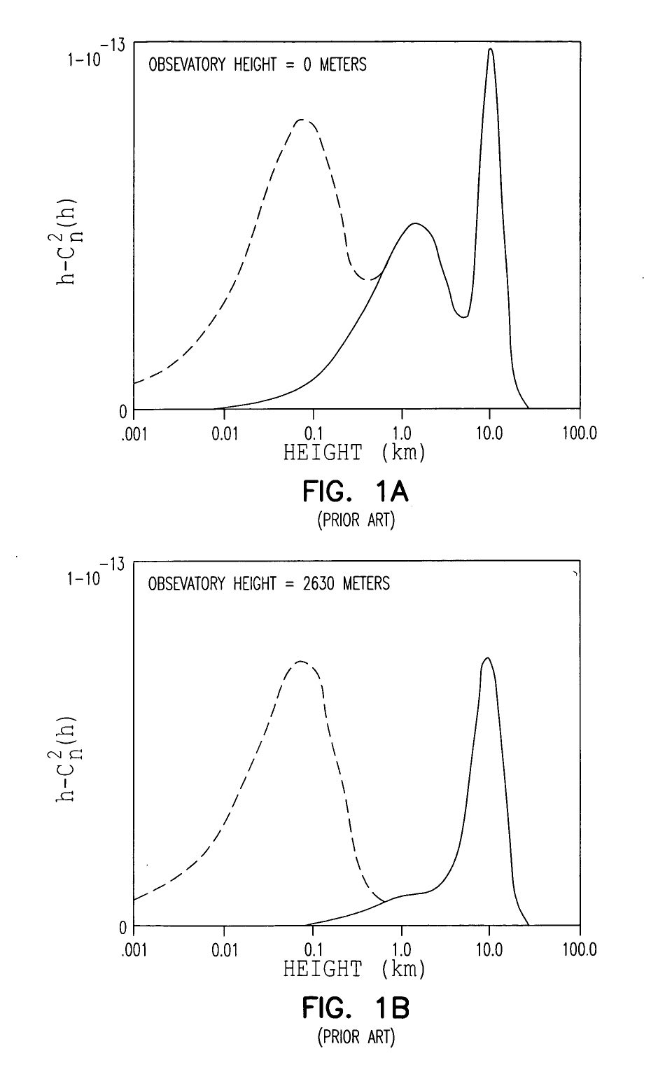

In general, turbulent refractive power is greater for a given horizontal path length, than for the same path length oriented vertically. This is because the turbulent power is vertically stratified, and, as FIGS. 1A-1B show, low level turbulence is particularly strong. The horizontal path is, of course, confined to the most turbulent layer.

The usual procedure in interpreting DIMM data is to refer measurements to a particular statistical model of the (spatial and time dependent) turbulent structure in the atmosphere. For moderate turbulence, the Rytov parameter derived from a single scattering model is used to characterize the atmosphere, while for strong turbulence, a multi-scattering Markov model is appropriate.

Embodiments for SDIMM systems are applied to provide apparatus and methods to characterize turbulent power along a defined path, without reference to a particular model. The model dependence of atmospheric characterization arises from the fact that turbulent cells have a distribution of sizes, and these are carried through the optical path by the wind. The cells are considered stationary in size and distributed along the path length, and the time dependence of fluctuations is considered to be induced by the wind carrying the cells through the path. This is referred to as the frozen atmosphere condition. Real atmospheric characterization detectors, including full atmosphere DIMM and SDIMM, sample the spatial scale typically at only one separation. This corresponds to the center-to-center spacing between receiver sub-apertures, and in a SDIMM embodiment, also corresponds to the spacing between sources.

Models of turbulent refractive scattering in the atmosphere derive from different assumptions, principally based upon the strength of the turbulence. The astronomical case illustrates the process. Through a near-vertical optical path, the Earth's atmosphere is assumed to transfer momentum vertically, leading to “ballistic” turbulent cells. These cells interact between a small “inner scale” that ultimately reflects the particle (molecular) nature of the atmosphere, to a large “uter scale” that reflects induced macroscopic turbulence induced by the wind-driven atmosphere's frictional interaction with the Earth's surface, vegetation or buildings.

For the free atmosphere, observed vertically, the induced turbulent power is characterized by several parameters, generally derived from the refractive structure constant, Cₙ². This structure constant, a function of altitude, describes the refractive turbulent power induced in the atmosphere as a function of altitude. From FIGS. 1A-1B, Cₙ² has a large value where peaks occur, including in the surface layer, and again at an altitude of about 10-km, for example.

Cₙ² can be measured as a function of altitude using lidar, sonic, and balloon-borne radiosonde techniques. Each of these techniques measures the atmosphere over vertical path lengths from the surface to 1-km-50-km altitudes. The surface layer from the ground to 100-m is not well sampled, especially considering the large contribution this layer makes to the total (integrated) turbulent power along the path length.

In various embodiments, a receiver having an aperture to collect light from a transmitting light source is used. In an embodiment, the receiver is a telescope of aperture diameter, D. In an embodiment, the receiver includes a Meade 10-inch Schmidt-Cassegrain telescope. Mounted at the entrance aperture of the telescope is a mask in which are cut sub-apertures of diameter, d, separated by distances rᵢ. In an embodiment, the sub-apertures are cut circular. The orientation of the aperture mask matches the distribution of sources, establishing multiple independent optical paths reaching from transmitter to receiver. In an embodiment, a receiver has two apertures, thus one baseline. The sub-apertures are about 5-cm in diameter, and are small enough to ensure wavefront phase coherence across the sub-aperture. For example, the sub-aperture radius may be less than or equal to Fried's parameter, r₀, for the vertical path length case.

In an embodiment, a telescope produces an image of each source through each sub-aperture. One source image through its matching aperture is selected as the reference beam, and the image is focused near the center of an area-format detector. A beam-steering system of two counter-rotating wedge prisms is used to move the direct images of successive sources onto the detector. This system allows the images to be analyzed to be placed in a relatively small detector, or a small area of a large detector. Placing the direct images together provides for read out of the fewest possible pixels of the array, which allows for operating at a faster frame rate. This is important, because the readout rate must be rapid enough to see the “frozen” refractive pattern as the wind carries it across the aperture. A goal is to sample the atmosphere at about a thousand samples per second (1-kHz rate). In an embodiment, a SDIMM system operates at 250-Hz, a rate which is fast enough for its application.

There is a design trade-off between sub-aperture size, frame rate, and the signal-to-noise ratio (S/N) of independent measurements. Larger sub-apertures allow more light into the system, but if they are too large, wavefront phase coherence is not maintained, and the signal (image motion) is diluted. Similarly, if the integration time per frame is increased to obtain a stronger signal (more light per exposure), the motion of the atmosphere blurs the measurement and again the signal is diluted.

Though each sub-aperture produces an image of each source and only one image is selected for measurement, embodiments of a SDIMM device do not “waste light,” for two reasons. The first reason is that only the direct image of each source produces the independent path length data the device measures. Secondly, any DIMM technique requires separation of images, by optical bandpass filtering or by polarization. Each of these separation techniques for DIMM is typically less efficient in terms of light throughput than is an embodiment of the SDIMM device.

Once aligned, each sub-aperture produces a direct image of its corresponding source on the area-format detector. The frame-to-frame differential motion of the centroids of the source images produces the raw data for the SDIMM technique.

In an embodiment, a computer system reads out a small section of the focal plane detector containing all relevant images. In an embodiment, a SDIMM system has two source images, and the area-format detector is a multiplexed readout CMOS device. The sub-array of the SDIMM prototype detector read out in this embodiment is approximately 128×128 pixels, which occurs at a rate of 250-Hz. The computer, or data system, analyzes the image data for relative image motion.

In an embodiment, a data system is based in the same computer that acquires the data. The computer may be an off-the-shelf personal computer (PC). The image analysis includes instrumental signature removal, as necessary. This typically involves removal of bias and flat-field effects, but must include all effects that could result in biased image centroids.

In an embodiment, the data system creates centroids by one of two techniques. The first is a straightforward calculation of the intensity weighted image centroid. The second is derivation of the image centroids by algebraic combination of high order image moments. The choice of algorithm depends upon computational precision and speed.

The output data are a time series of image centroids. In an embodiment, the centroids are analyzed by a stand-alone program, such as Matlab, Excel, IDL, or any other appropriate analysis tool with a suitable user interface. In an embodiment, a user interface may be embedded in the centroiding software for direct, near real-time data analysis.

Various embodiments for SDIMM techniques include production of bright, incoherent point sources, beam steering to a small, sub-array of a single detector, or alternative image centroid calculation techniques. In particular, such an embodiment of a SDIMM technique defines and maintains separate, independent path length measurement capability.

In an embodiment, a multi-source transmitter with one optical path per source is used with the multiples sources at known distances from corresponding receiver elements. Negative optics may be used to minify incoherent bright sources to produce point-like images from each source. Creating multiple independent optical paths, one per source, provides for sampling transverse spatially-dependent refractive power independently of where the power fluctuations occur along the optical path. Single source power measurements are insensitive to fluctuations at the source, and maximally sensitive at the receiver, with a linear dependence between source and receiver. For horizontal or vertical paths, use of multiple spatial baselines allows estimation of the spectral index (slope) of the spatial distribution function.

In an embodiment, a receiver optical system provides an array of source images on an area-format detector array. A receiver optical system includes a detector, which may be realized by a telescope with multiple sub-apertures. Each sub-aperture has a diameter of r₀ (or smaller) to ensure phase coherence across the sub-aperture. The number and geometric arrangement of the sub-apertures matches the geometry of the sources at the transmitter. Each sub-aperture creates an image of every source in the focal plane. For example, a two-path SDIMM produces four images in the focal plane. In an embodiment, an appropriate pair of images is selected by placing a pair of rotating wedge prisms over each sub-aperture (except for the first). The direct image formed by the first sub-aperture produces the reference image in the focal plane. The counter-rotating prisms on successive sub-apertures are used to position the direct image of each source near the reference source image on the area-format detector. Placement and separation of images is not critical, provided each sub-aperture is correctly identified and the images are sufficiently separated that they do not overlap. This allows precise calculation of the centroid of each image, the basic data from which is derived the turbulent refractive power.

In various embodiments, the relatively limited distance between the optical transmitter and the optical receiver limits the transverse distance over which the wavefront of the optical signal spreads at the receiver location. On the other hand, full atmosphere DIMM works with a single source (a star), where the star appears at an “infinite” (very large) distance. Thus, the wavefront produced by the star is planar over a (transverse) distance much larger than the full aperture of the receiver.

In an embodiment, a data system that reads an area-format detector, or a sub-array of the detector, and derives turbulent refractive power by correlating differential image motions over spatial baselines is used. The system operates at a frame rate sufficiently rapid that the frozen atmosphere assumption applies. That is, the refractive power can be characterized by a structure parameter, where the fluctuations are created by the wind carrying the atmosphere and its embedded structure through the optical path. The data system captures images at the appropriate rate from a fast-framing area-format detector. The instrumental signatures are removed, as necessary. Centroids of the point-like image of each source are calculated in real-time. The point-source image centroids are stored for later analysis, including averaging, RMS calculations, power spectral analysis, cross-correlation, and auto-correlation.

In an embodiment, a system includes two sources and two sub-apertures, thus one spatial baseline. For near-vertical pointed astronomical applications, the assumption of a Kolmogorov fluctuation distribution is appropriate, and the refractive structure constant, Cₙ², and the coherence scale derived from it, r₀, are valid atmospheric parameters. The system includes a data system that captures images at about 250 frames per second from a fast-framing area-format detector.

Various embodiments provide comprehensive techniques to characterize surface layer turbulence using simultaneous microthermal, SLAT-DIMM, and full-atmosphere measurements. For applications to astronomy, surface layer turbulence is measured and characterized since surface layer turbulence accounts for the majority of “seeing” at any given site. Surface layer turbulence can vary dramatically with local terrain, wind direction and altitude above ground. Thus, surface layer data may be used to determine placement to take advantage of locally optimal “seeing” and to design enclosures for new telescopes, aid decisions about improvements to existing telescopes (i.e. is it worth investing in a full-scale AO system or will a tip-tilt system suffice? Will improvements to telescope enclosures improve seeing or is the site dominated by the surface layer?), and monitor the atmosphere and the surface layer turbulence during observations to help guide queue-based observing and better understand data quality.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used.

1. An apparatus comprising:
a plurality of sources, each source to transmit energy;
a collector to receive the energy from each source; and
an analyzer to determine surface layer atmospheric turbulence based on perturbations along different paths traveled to the collector by the energy from each source relative to each other.

2. The apparatus of claim 1, wherein the collector includes a number of sub-apertures, the number of sub-apertures equal to the plurality of sources, each sub-aperture corresponding to a separate source and having a spacing from the other sub-apertures substantially matching the spacing between each source of the plurality of sources.

3. The apparatus of claim 1, wherein the apparatus is a system to provide information on atmospheric conditions to assist take-off and landing at airports.

4. The apparatus of claim 1, wherein the apparatus is a system to provide information on atmospheric surface layer turbulence conditions to assist in site selection for astronomical telescopes, optical systems, buildings, structures, or facilities.

5. The apparatus of claim 1, wherein the apparatus is a system to provide information on atmospheric conditions to provide data characterizing atmospheric surface layer turbulence.

6. An apparatus comprising:
a transmitter having multiple optical sources;
a receiver having a number of optical detectors; and
an analyzer to determine surface layer atmospheric turbulence based on differences in light traveling over different optical paths to the receiver, one optical path per optical source.

7. The apparatus of claim 6, wherein the receiver includes a number of sub-apertures, the number of sub-apertures equal to the multiple optical sources of the transmitter, each sub-aperture corresponding to a separate source of the multiple optical sources and having a spacing from the other sub-apertures of the number of sub-apertures substantially matching the spacing between each source of the multiple optical sources.

8. The apparatus of claim 7, wherein the apparatus includes a pair of rotating wedge prisms over each sub-aperture except for a first sub-aperture.

9. The apparatus of claim 6, wherein the multiple optical sources are multiple incoherent optical sources.

10. The apparatus of claim 6, wherein the multiple optical sources are multiple light emitting diodes.

11. The apparatus of claim 6, wherein the transmitter includes negative optics arranged to minify the multiple optical sources to produce point-like images from each optical source of the multiple optical sources.

12. The apparatus of claim 6, wherein the transmitter and the receiver are arranged such that each optical path from the transmitter to the receiver is substantially vertical through a surface layer of the atmosphere.

13. The apparatus of claim 6, wherein the transmitter and the receiver are arranged such that each optical path from the transmitter to the receiver is substantially horizontal through a surface layer of the atmosphere.

14. The apparatus of claim 6, wherein the number of optical detectors are adapted to place an array of source images on an area-format detector array.

15. The apparatus of claim 6, wherein the analyzer is adapted to derive turbulent refractive power by correlating differential image motions over spatial baselines.

16. The apparatus of claim 6, wherein the analyzer is adapted to capture images from the number of optical detectors, calculate image centroids of the captured images in real-time, and store the image centroids.

17. The apparatus of claim 16, wherein the images are point-like images.

18. The apparatus of claim 16, wherein the analyzer is adapted to analyze the images using one or more operations of averaging, root mean square calculations, power spectral analysis, cross-correlation analysis and auto-correlation analysis.

19. The apparatus of claim 6, wherein the receiver includes a telescope having multiple sub-apertures.

20. The apparatus of claim 6, wherein transmitter has two optical sources and the receiver has two optical detectors each using one sub-aperture.

21. The apparatus of claim 6, wherein transmitter has two LEDs and the receiver includes a telescope having two sub-apertures.

22. The apparatus of claim 6, wherein the analyzer operates at a frame rate sufficiently rapid such that a frozen atmosphere assumption applies.

23. The apparatus of claim 6, wherein the analyzer operates at 250 frames per second.

24. A method comprising:
generating energy at multiple sources;
collecting the energy from the multiple sources at a receiver having collection elements at a known distance from the multiple sources,
analyzing data from the collected energy to determine surface layer atmospheric turbulence based on perturbations along different paths traveled to the collector by the energy from each source relative to each other.

25. The method of claim 24, wherein collecting energy from the multiple sources includes collecting energy from the multiple sources at a number of sub-apertures of the receiver, the number of sub-apertures equal to the plurality of sources, each sub-aperture corresponding to a separate source and having a spacing from the other sub-apertures of the number of sub-apertures substantially matching the spacing between each source of the plurality of sources.

26. The method of claim 24, wherein generating energy at multiple sources includes generating energy at multiple optical sources.

27. The method of claim 24, wherein generating energy at multiple sources includes generating energy using multiple light emitting diodes.

28. The method of claim 24, wherein collecting energy from the multiple sources at a receiver includes collecting energy from the multiple sources at a telescope having multiple sub-apertures.

29. The method of claim 24, wherein analyzing data from the collected energy includes using differential image motion measurement techniques on images corresponding to the collected energy.

30. The method of claim 24, wherein collecting the energy from the multiple sources includes collecting light from optical sources and forming selected images.

31. The method of claim 30, wherein forming selected images includes blocking unwanted images.

32. The method of claim 31, wherein blocking unwanted images includes using rotating wedge prisms over a sub-aperture of the receiver.

33. The method of claim 24, wherein analyzing data from the collected energy includes analyzing stored images of the collected energy using one or more operations of averaging, root mean square calculations, power spectral analysis, cross-correlation analysis and auto-correlation analysis.

34. The method of claim 24, wherein analyzing data from the collected energy includes analyzing images of collected optical energy using a frame rate sufficiently rapid such that a frozen atmosphere assumption applies.
